(19) United States
(12) Patent Application Publication
(10) Pub. No.: US 2004/0024864 A1
(43) Pub. Date: Feb. 5, 2004

(54) User, process, and application tracking in an intrusion detection system

(76) Inventors: Phillip Andrew Porras, Cupertino, CA (US); Martin Wayne Fong, San Francisco, CA (US)

Correspondence Address: MOSER PATTERSON & SHERIDAN LLP, 595 SHREWSBURY AVENUE-SUITE 100, SHREWSBURY, NJ, 07702, US

(21) Appl. No.: 10/209,596

(22) Filed: Jul. 31, 2002

(51) Int. Cl. G06F 15/173

(52) U.S. Cl. 709/224; 713/201

(57) ABSTRACT

Preferred embodiments combine audit records with other relevant information to identify and track the users, processes or applications responsible for an attack. Information that identifies a user, process, or application may be associated with subsequent audit records related to the user or process session; this information may also be associated with IDS alerts related to the session. By reliably identifying the source of user and process sessions, the preferred embodiments make it possible to selectively target the sessions and applications that are related to an intrusion or attack.

### TECHNICAL FIELD

This invention relates generally to computer security, and more specifically to host-based intrusion detection systems.

### BACKGROUND

An intrusion detection system (IDS) analyzes a stream of events that take place in a computer or network, and generates alerts (which are usually displayed on the IDS operator's console) when an attack or intrusion is detected. There are currently two main types of intrusion detection systems: network-based IDSs, which analyze data traffic flowing over a computer network, and host-based IDSs, which typically analyze information from audit records generated by the host computer's operating system. Audit records include information about system calls (operating system routines executed on the host computer), and may include some information about sessions (the communications between a user or process and the host computer during a connection). U.S. patent application Ser. No. US 2002/0046275A1 entitled “System and Method for Host and Network Based Intrusion Detection and Response” provides a description of a typical host-based intrusion detection system.

Although analysis of network traffic allows the detection of certain types of attacks that may not be reflected in host computer audit records, the analysis of audit records provides an exceptional degree of insight into the processes executing within a host computer. By analyzing audit records, all access control decisions occurring between the operating system kernel and user processes can be examined, process activity can be analyzed to determine what activity is “normal,” and user actions can be compared against their expected roles within the system.

In practice, the simultaneous use of host- and network-based IDSs can be much more effective than the use of either type of IDS alone. However, both types of IDSs still have limitations that make it difficult to take effective countermeasures against certain types of attacks. For example, an insider attack on a host computer may not generate network traffic that can be analyzed by a network-based IDS; and although the operating system audit records may provide enough information for a host-based IDS to detect an attack, they may not provide enough information for the IDS to identify the users, processes, and/or applications responsible for the attack. Accordingly, there remains a need for an IDS that acquires and processes a sufficient amount of information to identify and track the users, processes, and/or applications responsible for an attack.

### SUMMARY

Preferred embodiments meet these needs by combining host computer audit records with other relevant information to identify and track the users, processes, and/or applications responsible for an attack. Information that identifies a user, process, or application may be associated with subsequent audit records related to the user or process session; this information may also be associated with IDS alerts related to the session. By reliably identifying the source and activities of user and process sessions, the preferred embodiments make it possible to take action against only those sessions and applications that are related to an attack.

### DESCRIPTION OF DRAWINGS

FIG. 1 is a diagram showing the flow of data in a preferred intrusion detection system.

FIG. 2 is a flowchart showing a preferred method for associating audit record data with other relevant data.

FIG. 3 is a flowchart showing a preferred method for identifying the source of a suspicious session.

FIG. 4 is a flowchart showing a preferred method for associating an application pathname with a process identifier.

FIG. 5 is a flowchart showing a preferred method for associating the IP address of a remote user with subsequent audit records of a user session.

FIG. 6 is a flowchart showing a preferred method for associating the IP address of a source of suspicious activity with IDS alerts related to the suspicious activity.

FIG. 7 is a flowchart showing a preferred method for associating an application executed by a suspicious process with IDS alerts related to the suspicious process.

### DETAILED DESCRIPTION

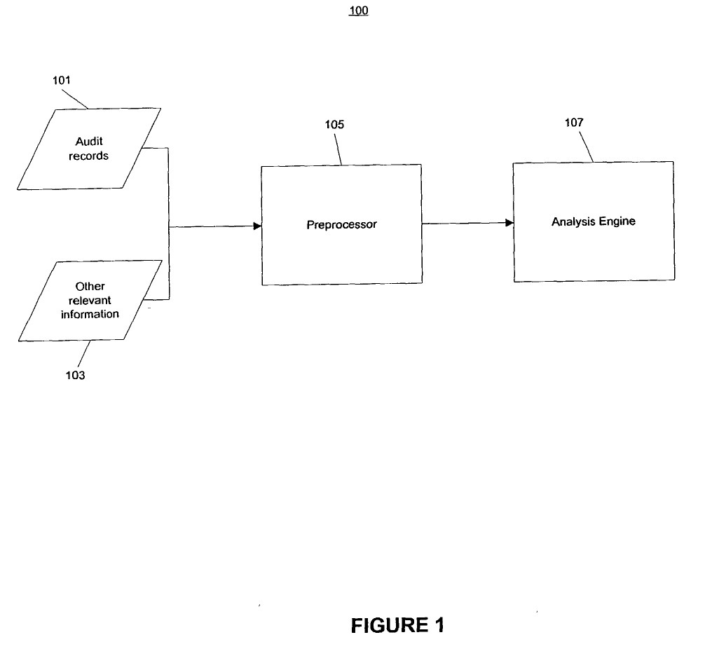

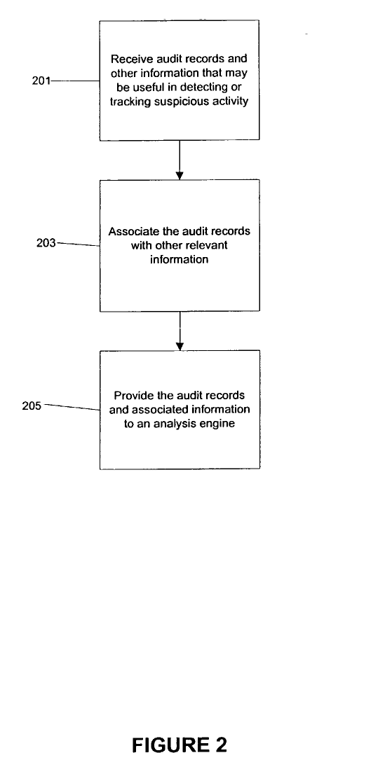

In the IDS 100 shown in FIG. 1, audit records 101 and other relevant information 103 are received by a preprocessor 105 (see also step 201 of FIG. 2). The preprocessor combines or associates information from the audit records with the other relevant information (see also step 203 of FIG. 2), and then provides combined or associated information to the IDS's analysis engine 107 (see also step 205 of FIG. 2). The analysis engine preferably operates in a conventional manner. If the analysis engine determines that an intrusion or attack has taken place, an alert describing the intrusion is generated, which may be transmitted to the IDS operator's control console (not shown). By combining host computer audit records with other relevant information, the preferred embodiments make it possible for an IDS to identify the users, processes, and/or applications responsible for attack.

A host computer's audit records are usually generated by the operating system's kernel. The kernel is a trusted component of the operating system that always resides in the host's main memory. In a preferred embodiment, the kernel audit records are received in real time by a preprocessor application that also resides in the host computer's main memory; this makes it much more difficult for an attacker to modify or delete the audit records. In another embodiment, the audit records may be stored on disk or in another memory, and analyzed either periodically or as needed.

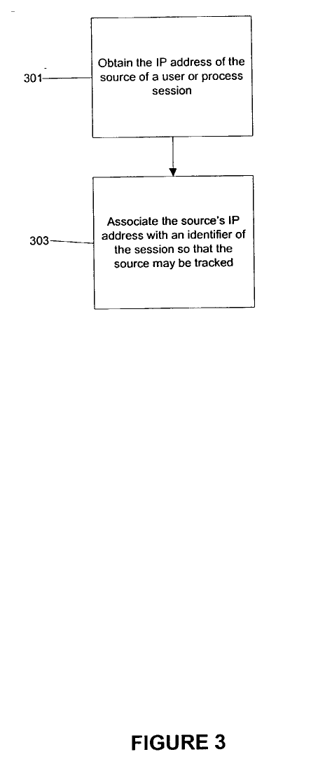

FIG. 3 illustrates a preferred method for associating the IP address of the source of a user or process session with a session identifier. This allows the source to be identified if an IDS determines that the session is part of an attack on the host computer. In this method, the IP address of the source of the user or process session is acquired (step 301). In a Unix, Unix-like or Windows environment, the IP address may be obtained from an audit record that records or represents a network communication establishment event, such as an original InetD record or an Accept record. Next, the source's IP address is associated with an identifier of the session (step 303). The session identifier is typically found in the host computer's kernel audit records.

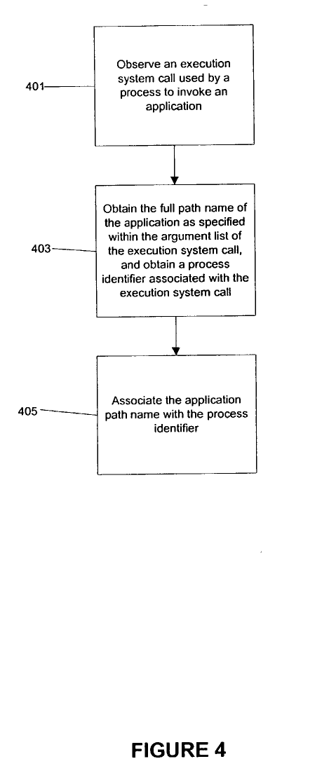

In another preferred method illustrated in FIG. 4, the applications invoked by a process are associated with the process's identifier. If the IDS determines that the process is associated with an attack, it will also be able to identify all of the applications invoked by that process. In this method, when an execution system call used by a process to invoke an application is observed (step 401), the full pathname of the application (which is specified in the argument list of the system call) and an identifier of the process are acquired (step 403). The full pathname of the application may be obtained from the path list field of the system call audit record (such as an exec record), and the process identifier may be obtained from an audit record that records or represents a network communication establishment event (such as an original InetD record or an Accept record). The process identifier and application pathname are then associated or linked (step 405), so that subsequent audit records for the process will also include information about the applications invoked by that process. The association step may be performed by mapping the path list field of the system call audit records to those records' process identifier fields.

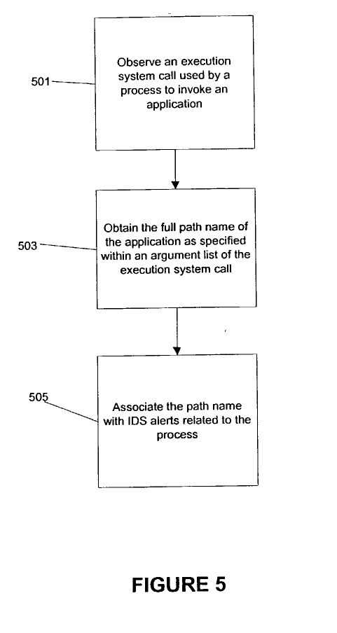

FIG. 5 shows a variation of the method illustrated in FIG. 4. In this method, when an execution system call used by a process to invoke an application is observed (step 501), the full pathname of the application (as specified within an argument list of the execution system call) is acquired (step 503). If an IDS identifies the process as suspicious, the pathnames of applications invoked by the process are associated with IDS alerts related to the suspicious process (step 505). This information allows the IDS operator or system administrator to take selective action against the applications invoked or controlled by the suspicious process.

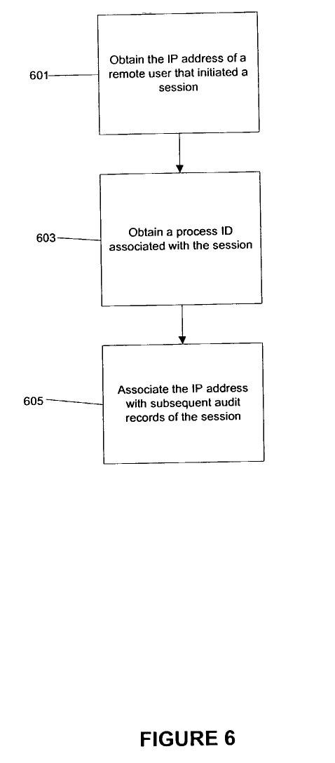

In another preferred method illustrated by FIG. 6, the IP address of a remote user that initiated a session is associated with subsequent audit records of the session. In this method, the IP address of a remote user that initiated session is acquired (step 601), preferably from an audit record that records or represents a network communication establishment event. Next, the process identifier associated with the session is acquired (step 603); this process identifier may also be obtained from an audit record that records or represents a network communication establishment event. This information is then used to associate the IP address of the remote user with subsequent audit records of the session (step 605), which also have a process identifier for the session.

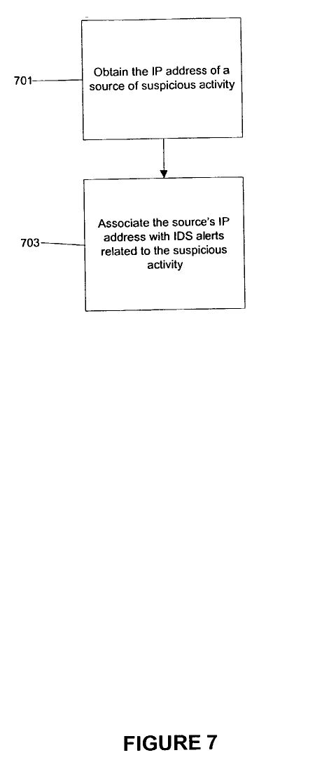

FIG. 7 shows a variation of the method illustrated in FIG. 6. In this method, the IP address of a source of suspicious activity is acquired (step 701), and then associated with IDS alerts related to the suspicious activity (step 703). By associating the source of an attack with IDS alerts related to the attack, it may be easier for an IDS administrator to take effective action against the attack; it may also be easier for the administrator understand the nature of the attack if the IDS generates lots of alerts simultaneously.

Other embodiments are within the scope of the following claims.

What is claimed is:

1. In a computer system including operating system software that generates audit records, a method for tracking in real time a source of a user or process session comprising the steps of:
obtaining the source's IP address;
obtaining a session identifier from the operating system audit records; and
associating the source's IP address with the session identifier.

2. The method of claim 1 wherein the source's IP address is obtained from an audit record that records or represents a network communication establishment event.

3. The method of claim 2 wherein the audit record that records or represents a network communication establishment event is an InetD record.

4. The method of claim 2 wherein the audit record that records or represents a network communication establishment event is an Accept record.

5. The method of claim 1 wherein the computer system has a main memory and the operating system has a kernel that resides in the main memory.

6. The method of claim 5 wherein the operating system audit trail records are generated using software that resides in the main memory.

7. The method of claim 6 wherein the method is performed by software that resides in the main memory.

8. In a computer system including operating system software that generates audit records and in which a process uses an execution system call to request invocation of an application, a method for tracking in real time the application's path name comprising the steps of:
observing the execution system call;
obtaining a full path name of the application as specified within an argument list of the execution system call;
obtaining from an execution system call audit record a process identifier associated with the execution system call; and
associating the application path name with the process identifier.

9. The method of claim 8 wherein the execution system call audit record has a path list field and a process identifier field.

10. The method of claim 9 wherein the association step is performed by mapping an execution system call audit record's path list field to the execution system call audit record's process identifier field.

11. In a computer system including operating system software that generates audit records, a method for tracking in real time a remote user during a session initiated by the remote user, the method comprising the steps of:
obtaining the remote user's IP address;
obtaining a process identifier associated with the session from an audit record; and
associating the process identifier with the IP address.

12. The method of claim 11 wherein the remote user's IP address is obtained from an audit record that records or represents a network communication establishment event.

13. The method of claim 12 wherein the audit record that records or represents a network communication establishment event is an InetD record.

14. The method of claim 12 wherein the audit record that records or represents a network communication establishment event is an Accept record.

15. The method of claim 11 wherein the audit records include a remote IP address field and a process identifier field.

16. The method of claim 15 wherein all subsequent audit records for the session are then associated with or augmented to include the remote IP address.

17. In an intrusion detection system in which alerts are generated in response to a suspicious activity, a method for tracking a source of the suspicious activity comprising the steps of:
obtaining the source's IP address; and
associating the source's IP address with alerts related to the suspicious activity.

18. The method of claim 17 wherein the intrusion detection system is host-based.

19. In an intrusion detection system in which alerts are generated in response to a suspicious process, a method for tracking a path name of an application invoked by the suspicious process, the method comprising the steps of:
observing an execution system call used by the suspicious process to invoke the application;
obtaining a full path name of the application as specified within an argument list of the execution system call; and
associating the path name with alerts related to the suspicious process.

20. The method of claim 19 wherein the intrusion detection system is host-based.
